(19) United States
(12) Patent Application Publication
(10) Pub. No.: US 2026/0128993 A1
(43) Pub. Date: May 7, 2026

(54) STATE-BASED NETWORK SEGMENTATION IN A NETWORK DEVICE

(71) Applicant: Hewlett Packard Enterprise Development LP, Spring, TX (US)

(72) Inventors: Venkatavaradhan Devarajan, Bangalore (IN); Balaji Sankaran, Bangalore (IN); GopalaKrishna Tellapalli, Bangalore (IN)

(21) Appl. No.: 18/939,758

(22) Filed: Nov. 7, 2024

(51) Int. Cl. H04L 47/20

(52) U.S. Cl. CPC H04L 47/20

(57) ABSTRACT

Methods and systems relate to packet forwarding that includes a network device receiving a message from a second network device and that has a destination address of a third network device. The circuitry of the network device determines that a connection between the second network device and the third network device has been previously opened by the third network device. In response to the determination that the connection is open and in response to receiving the message, the circuitry transmits the message towards the third network device.

### BACKGROUND

Local area networks (LANs) and/or other networks include multiple network devices connected together. Often these networks may utilize a network access switch (NAS) to enable a connection between other network devices. For instance, a NAS may couple a client device to the network(s) through which the client device may communicate with to enable certain actions and/or control operations for the client device.

### BRIEF DESCRIPTION OF DRAWINGS

Features, aspects, and advantages of the present disclosure will become better understood when the following detailed description is read with reference to the accompanying drawings in which like characters represent like parts throughout the drawings, wherein:

FIG. 1 is a flow diagram illustrating a system that includes a network between multiple network devices that couple through other network devices, such as a network access switch (NAS), in accordance with aspects of the present disclosure;

FIG. 2 is a diagram of a system (e.g., the system of FIG. 1) that uses a network firewall to enhance security of communications through its corresponding network, in accordance with aspects of the present disclosure;

FIG. 3 is a diagram of a computing system that includes at least one application specific integrated circuit (ASIC) and at least one processing resource that may be used in network devices, such as the network devices of the system of FIG. 1, in accordance with aspects of the present disclosure;

FIG. 4 is a diagram illustrating operations in a network device using circuitry and/or processing resources of the network device, in accordance with aspects of the present disclosure;

FIG. 5 is a flow diagram for applying a stateful access control list (ACL) in a network device, in accordance with aspects of the present disclosure;

FIG. 6 is a diagram illustrating operations in a network device, such as a multi-part NAS, using circuitry and/or processing resources of the network device, in accordance with aspects of the present disclosure;

FIG. 7 is a flow diagram of a process that may be deployed by processing resources and/or circuitry in network operations to implement state-based network segmentation and policy enforcement, in accordance with aspects of the present disclosure; and

FIG. 8 is a flow diagram of a process that may be deployed by processing resources and/or circuitry in network operations to implement state-based network segmentation and policy enforcement, in accordance with aspects of the present disclosure.

### DETAILED DESCRIPTION

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Aspects provided herein relate to techniques for implementing network segmentation and policy enforcement in local area networks (LANs) that use states to implement directionality in a network access switch (NAS) that may not be available in traditional stateless NAS devices. Specifically, the NAS may enable a connection between network devices. For instance, the network devices may include a client, such as a door badge sensor, door lock, an Internet of Things (IoT) device, and/or any other device that may utilize a network connection through the NAS. Additionally or alternatively, the network devices may include a server, such as a door badge admission controller, a database, and/or any other device that may perform actions based on instructions from other network devices. This second network device (e.g., a server) may be permitted to communicate with the other network device (e.g., the client) when the other network device initiates the connection or a connection is already open between the two devices. For instance, the connection may be already open if the other network device has previously opened the connection. By ensuring that connections can be opened from a single side of the network connections, the communications between the network devices may be secured more strongly against potential attacks attempting to intrude on the network.

As discussed below, NAS devices ASICs and/or other network devices include an IP flow table that is indexed by multiple tuples, such as virtual routing and forward (VRF), source address, source port, destination address, destination port, and IP protocol tuples. The IP flow table caches the multi-tuple flows that one or more ASICs see on their ingress data paths. This table may be software managed by at least one processing resource of the network device to track traffic to and/or from end points that may be used for telemetry and/or other analytics. As discussed here, the IP flow table lookup hit/miss results may be used by the circuitry (e.g., ASIC) of the network device along with a data path policy table lookup to implement a stateful policy enforcement.

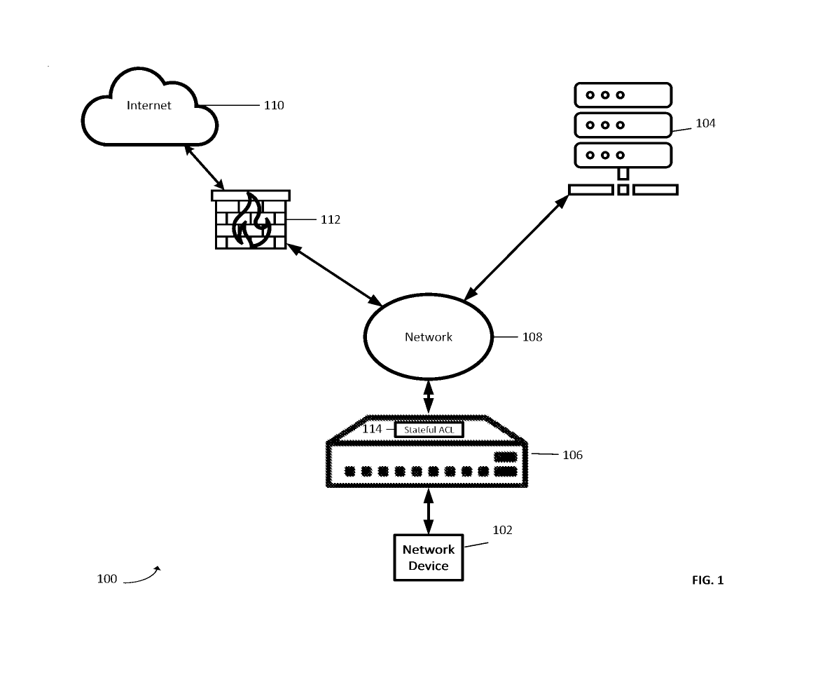

With the foregoing in mind, FIG. 1 is a diagram illustrating a system 100 that includes network devices 102 and 104. The network devices 102 and 104 may connect to each other through one or more network devices 106 and/or a network 108. The network device 106 may be a network access switch (NAS) device or another network device that connects the network device 102 to the network 108.

The network 108 may be multiple electronic devices and/or connections between devices through which communication may be made between the network device 102, the network device 104, and/or other network devices of the network 108. The network 108 may be an entire network on its own and/or may be a network segment that is a part of a larger network. In some implementations, the network device 106 may be part of the network 108 while in other implementations the network device 106 may be outside of the network 108 while providing connectivity to the network 108 for the network device 102. The network devices 102 and 104 may be part of the network 108 or may be outside of the network but may communicate with each other through one or more devices (e.g., switches, routers, etc.) in the network 108. For instance, the network devices 102 and 104 may be in different networks that use the network 108 as a communication pathway between their respective networks.

In some implementations, one or more devices, such as the network device 104, may connect to the Internet 110 through the network 108. To secure the network 108 and any connected devices from potential unwanted access via the Internet 110, the network 108 uses a firewall 112 to use predefined policies to allow or deny packets based on the policies. In other words, the firewall 112 provides a barrier between secured networks (e.g., the network 108) and unsecured networks (e.g., the Internet 110) to protect against unauthorized access and/or security threats. Generally, firewalls protect devices internal to a network from devices outside of the network and can use policies and/or packet scrutiny to filter and prevent suspicious communications.

In some implementations, the network device 102 may act as a client device that initiates a request for a connection to the network device 104 through the network 108. Since the network device 102 initiates the request for connection with the network device 104, the network device 104 may act as a server that services requests from the network device 102.

In certain implementations, the network device 102 may not be expected to accept an authentic incoming connection from a remote endpoint (e.g., the network device 104) without first initiating and opening a connection with the remote endpoint. For instance, the network device 102 may be a badge sensor with the network device 104 as a door badge admission controller. In such implementations where the network device 102 acts as the client, the network device 102 may receive authentic communications from the network device 104 when it has first sent a request to the network device 104.

If the network device 102 is expected to function as a client rather than a server, the network device 106 may control access to the network device 102 by identifying an allowed pattern of outgoing communications from the network device 102 to any remote device (e.g., the network device 104) and enabling return communications when there is an open connection between the remote device (e.g., the network device 104) and the network device 102 and blocking return communications without an open preexisting connection.

By securing contacts to such expected patterns with directionality, the network device 106 may prevent/reduce the likelihood of security breaches, such as reconnaissance attacks or lateral movement attempts by a compromised device in a network to spread malware. To implement tracking these patterns, the network device 106 may implement a stateful access control list (ACL) 114 that factors in direction of communications and/or current connection status to protect communications within the network 108 and/or its segments rather than using stateless ACLs that merely control which devices can talk to each other without discerning directionality and/or current connection status.

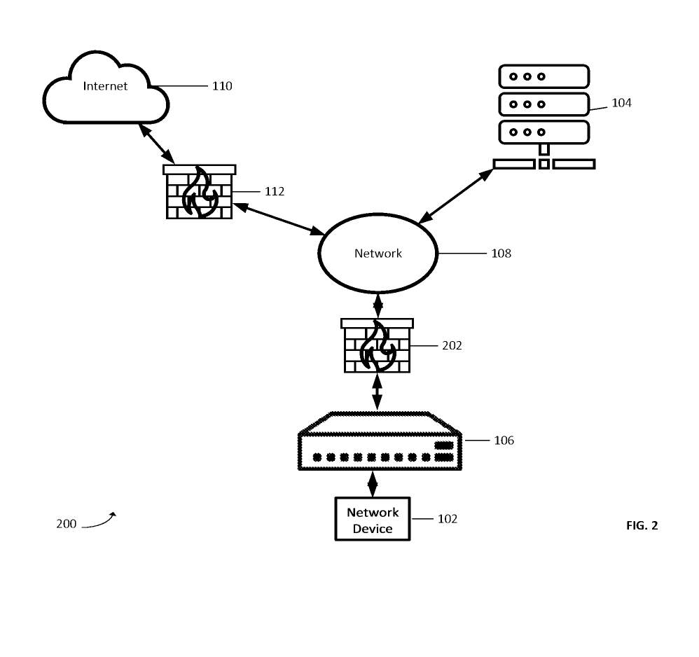

FIG. 2 shows a system 200 where a firewall 202 may be used to add directionality and current connection status related controls in an aggregation layer to inspect all inter-VLAN traffic to examine states before allowing communication to pass. This firewall 202 may be added to the stateful ACL 114 implemented in the network device 106 or may be in place of the stateful ACL 114 implemented using the network device 106.

Since the firewall 112 is located at a perimeter of the network or in the cloud for system as a service platform, communications within the network 108 that are not external relative to the firewall 112 are not firewalled until the firewall 202 is added. In large networks and/or physical facilities, a perimeter may be many layers and/or hops away from an endpoint (e.g., the network device 102). Thus, traffic that does not hit the Internet 110 or other locations through the firewall 112, the firewall 112 may be unable to inspect such traffic creating a potential segmentation hole for traffic within the system 100.

One or more firewalls 202 may be added to secure such segmentation holes. For example, a firewall 202 secures internal communications between the network device 102 and the network device 104 in a network segment. For instance, the firewall 202 may be part of a layer 3 gateway (L3GW) node that performs routing functions in addition to switching while firewall protections that may serve as a de facto authentication and policy enforcement point for locally attached endpoints.

Deploying such L3GW/aggregation or other types of firewalls may greatly increase the total cost of ownership for customers as firewalls may be costly financially and/or in other resources (e.g., power, administrative costs, etc.). Furthermore, as bandwidth grows, the firewall costs may increase exponentially especially when compared to non-firewall switches. Moreover, to lock down such networks and/or segments, each access switch would incorporate a firewall to ensure that no devices are connected without corresponding firewall protections. Instead, as discussed below, the stateful segmentation may be embedded into the network device 106 (e.g., an access switch/NAS device) using the stateful ACL 114.

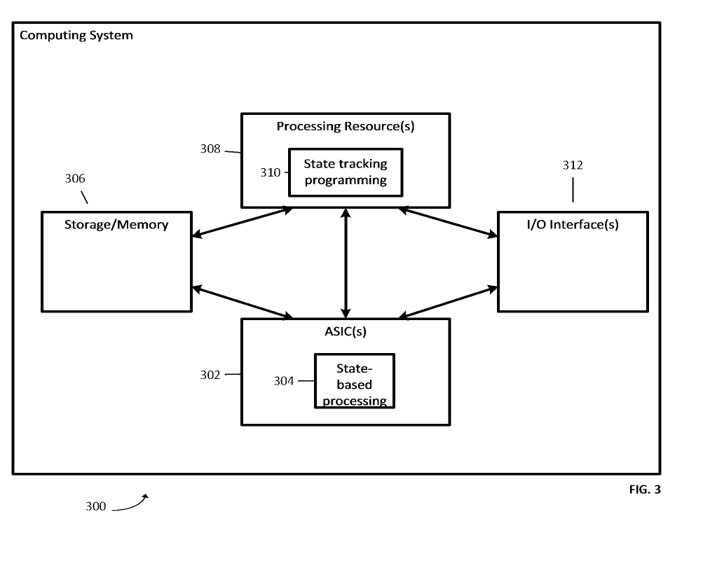

FIG. 3 is a diagram, illustrating a computing system 300. The computing system 300 may be implemented on any network device, such as the network device 106 of FIG. 1. The computing system 300 includes one or more application specific integrated circuits (ASICs) 302. The one or more ASICs 302 may include an integrated circuit that is purpose built to provide network throughput through the network device 106. Generally, the one or more ASICs 302 provide packet forwarding at a speed that is multiple orders of magnitude greater than a general purpose central processing unit (CPU) is capable of providing packet forwarding. These ASICs 302 may be chips that may be optimized for a particular type of connection, such as Ethernet. These ASICs 302 may include on-chip buffering that includes policy tables used to specify policies on which packets are forwarded/allowed and which are blocked/dropped. The one or more ASICs 302 may also implement flow tables that track flows through the one or more ASICs 302. Using these policy tables and flow tables, the one or more ASICs 302 implements state-based processing 304 to determine which packets to allow and which packets to block based on states of connections and/or directionality of communications through the computing system 300. For instance, the state-based processing 304 may be used to implement the stateful ACL 114.

In addition to any on-chip buffers of the one or more ASICs 302, the computing system 300 also includes storage/memory 306 to which the one or more ASICs 302 may have access. The storage/memory 306 may include any suitable articles of manufacture suitable for storing data and/or executable instructions. For instance, the storage/memory 306 may include a storage device, such as a Non-Volatile Memory Express (NVMe) device, a hard disk drive (HDD), a solid-state drive (SSD), an optical drive, flash memory, read-only memory (ROM), or any combination thereof. The storage/memory 306 includes memory that may include any suitable class of memory devices, such as a double data rate type 5 (DDR5) synchronous dynamic random-access memory (SDRAM) device, double data rate type 4 (DDR4) SDRAM device, low-power double data rate (LPDDR) SDRAM device, another suitable type of memory device, or any combination thereof. In some implementations, the one or more ASICs 302 store the policy table, the flow table, settings, and/or other data used in controlling how the one or more ASICs 302, and thus the computing system 300 behaves in allowing or blocking communications as forwarded packets.

The computing system 300 also includes one or more processing resources 308. The one or more processing resources 308 may include a central processing unit (CPU), a graphics processing unit (GPU), a processor implemented using a field programmable gate array (FPGA) or other programmable logic device, another processor type, or a combination thereof. The one or more processing resources 308 may be operably coupled with the storage/memory 306 to facilitate the use of the one or more processing resources 308 to implement various stored programs. Such programs or instructions executed by the one or more processing resources 308 may be stored in any suitable article of manufacture that includes one or more non-transitory and computer-readable media at least collectively storing the instructions or routines.

In addition, programs encoded on such a computer program product of the articles of manufacture may also include instructions that may be executed by the one or more processing resources 308 to enable the computing system 300 to provide various functionalities. For instance, the programs implemented by the one or more processing resources 308 using the instructions stored on the non-transitory, computer-readable medium of the storage/memory 306 may be used to perform state tracking programming 310. For instance, the processing resources 308 may use the instructions stored in the storage/memory 306 to create flow entries in the flow tables for communications through the computing system 300 by programming the flow tables.

The computing system 300 also includes input-output (I/O) interfaces 312 that enable other remote devices and/or a user to transmit data to and/or receive data from the computing system 300. The I/O interfaces 312 couple to multiple devices (e.g., the network devices 102 and 104). This connection to multiple devices and selective packet forwarding via the one or more ASICs 302 enable the computing system 300 to act as a switch for other devices connected to the computing system 300 via the I/O interfaces 312. The I/O interfaces 312 may include, for example, one or more network interfaces for a personal area network (PAN), such as a Bluetooth network, for a local area network (LAN) or wireless local area network (WLAN), such as an IEEE 802.11x Wi-Fi network, an IEEE 802.15.4 wireless network, an Ethernet network, and/or for a wide area network (WAN), such as a cellular network. The I/O interfaces 312 may additionally or alternatively include one or more interfaces for, for example, broadband fixed wireless access networks (WiMAX), mobile broadband Wireless networks (mobile WiMAX), and so forth. The I/O interfaces 312 may include additional interface types, such as a Universal Serial Bus (USB) interface, a coaxial cable interface, or a combination thereof.

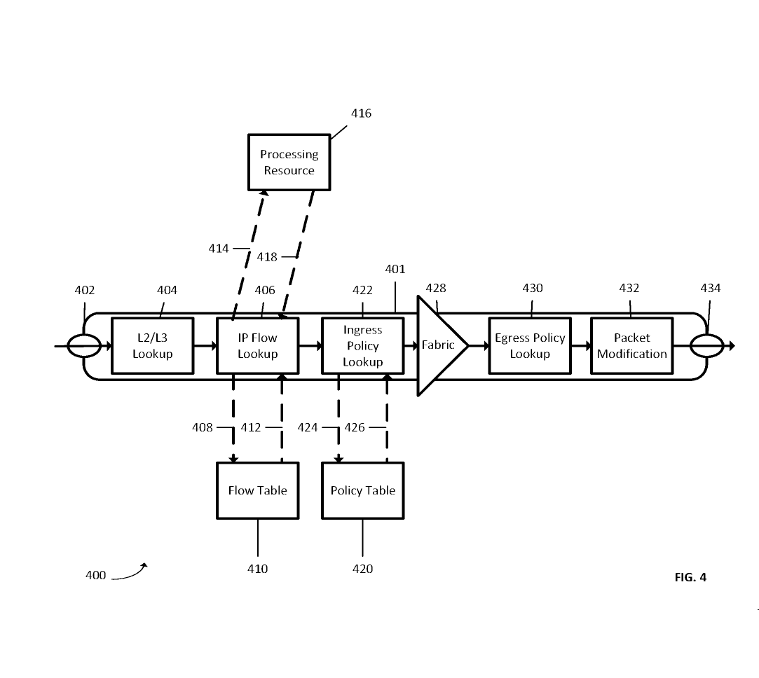

FIG. 4 is a flow diagram 400 performed using the circuitry 401 of a network device, such as the network device 106. For instance, the circuitry 401 may be the one or more ASICs 302 of a network device. As illustrated, the circuitry 401 receives incoming data packets at an in port 402. The in port 402 may be any connection to an external device, such as the network device 102 or the network device 104, that may receive a packet. The port may use a respective connection, such as an I/O interface 312. For instance, the in port 402 may receive a packet via an Ethernet connection or another layer 1/physical layer connection from the network device 102 and convert values on the physical layer to bits. Moreover, the in port 402 may be capable of receiving an input packet and/or sending output packets.

The circuitry 401 then performs layer 2 and/or layer 3 lookups using layer 2 and/or layer 3 lookup circuitry 404. In some implementations, the circuitry 401, such as the one or more ASICs 302, may implement layer 2 forwarding tables. As such, the circuitry 401 uses the layer 2 forwarding tables to map forwarding of packets using media access control (MAC) addresses and/or logical link control (LLC) to track which output ports are to be used for which destinations. In addition to or alternative to layer 2 forwarding, the circuitry 401 may implement layer 3 networking to lookup the next hop address in a routing table based on a destination IP address.

The circuitry 401 then performs an Internet Protocol (IP) flow lookup using an IP flow lookup circuitry 406 by looking up in and/or sending a request 408 to a flow table 410. The circuitry 401 uses the flow table 410 to forward, modify, and look up packets and includes an entry for each flow through the circuitry 401 that classifies each packet into a specific flow.

The flow table 410 may be a hash table implemented in a buffer of the circuitry 401 and may be indexed by virtual routing and forwarding (VRF), source IP address, source port, destination IP address, and IP protocol type. The VRF is a layer 3 level isolation mechanism that enables separation of traffic between different virtual private networks (VPNs). For instance, a first packet with a first VRF is isolated from a second packet with a second VRF enabling a single pathway to be treated as different pipelines. The source IP address and the source port identify the IP address and port from which packets are received in a flow of the flow table 410. The destination IP address and the destination port identify the IP address and port to which packets are destined in the flow of the flow table 410. The IP protocol type indicates a type of IP protocol. For instance, the IP protocol type may specify IP version 4 (IPv4), IP version 6 (IPv6), or another version of the IP.

The circuitry 401 obtains a response 412 that is a result of the lookup of the flow table 410. For instance, the response 412 may include an indication that an incoming packet matches a flow in the flow table or is a flow miss. In response to a flow miss, the circuitry 401 sends a flow miss notification 414 to at least one processing resource 416 indicating that the packet does not match a current flow in the flow table.

In response to the flow miss notification 414, the at least one processing resource 416 performs updates to the flow table 410 via programming operation 418. For instance, if a packet received from a client does not correspond to an entry in the flow table 410, the at least one processing resource 416 may create a flow in the flow table that matches the VRF, source IP address, source port, destination IP address, destination port, and IP protocol type of the packet. In addition, the at least one processing resource 416 may create a reverse flow with the destination IP address and port replacing the respective source IP address and port and vice versa. In other words, the reverse flow is a flow in the exact opposite direction of the flow.

The creation of the forward and reverse flows by the at least one processing resource 416 may be based on policy. This policy may be stored in a policy table 420 implemented in the circuitry 401 and/or in external memory, such as the storage/memory 306. The policy table 420 may be a literal table or may be any location where policies are stored. For example, the policy table 420 may include a first policy to allow all communications from a first network device (e.g., the network device 102). This allowance may be indicated by role, such as door badge sensor, camera, and/or any other role in the network. Additionally or alternatively, this policy may be defined on an address basis, such as IP addresses by specific IP addresses and/or by a subnet. Another defined policy may indicate that transmissions from endpoints back to the first network device are to be allowed when responding to messages from the first network device. In other words, responses to the first network device are to be allowed if a connection is already open. If no connection is open, any transmissions to the first network device are dropped without transmission to the first network device. These principles may be defined using two policies: 1) transmit all packets from the first network device while having the at least one processing resource 416 program a reverse flow and a forward flow when a flow table miss notification 414 is received based on a packet from the first network device and 2) transmit packets to the first network device when the packets match a flow in the flow table.

Furthermore, the first network device may close/terminate an open session/connection that it had previously opened. In such a situation, it may instruct the at least one processing resource 416 to reprogram the flow table 410 to remove the flow and any corresponding flows, such as a corresponding reverse flow. In some implementations, the reverse flow is created with the source and destination values inverted to cover both directions based on a single flow table miss notification 414 due to a received packet not matching the flow table 410.

In certain implementations, the at least one processing resource 416 may close the connection for reasons in addition to or in place of the explicit closing by the first network device. For instance, the computing system 400/at least one processing resource 416 may track how long it has been since the first network device sent a communication/packet to the second network device. When that duration exceeds a threshold, the at least one processing resource 416 may terminate the connection by deleting the forward and reverse flows to prevent stale unused connections potentially causing security issues. Additionally or alternatively, the computing system 400/at least one processing resource 416 may track how many responses have been received from the second network device since the last message/packet from the first network device. If that number exceeds a threshold in total or over a specified period of time, the computing system 400/at least one processing resource 416 may delete the forward and reverse flows to prevent a potentially compromised second network device from creating more issues in the network and/or to prevent the second network device from overly consuming network resources. This threshold may be set to a level that is much greater than expected in authentic communications so that such closing of the connection occurs when the second network device sends a much larger amount of data than expected via the open connection. For instance, if the second network device sends 2x, 4x, 8x, or more times the amount of expected data and/or separate messages, the first network device may close the connection.

Using the policy table 420, the circuitry 401 performs an ingress policy lookup using ingress policy lookup circuitry 422 by searching/requesting 424 whether a packet is to be transmitted. For instance, the circuitry 401 may search locally if the policy table is local but may send a request to an external policy table. If the policy table 420 indicates that a received packet matches a policy to transmit (e.g., based on role or address of the source) all packets from the first network device in a response 426, the circuitry 401 transmits any packet from that source. The policy table 420 may indicate that a received packet matches a policy to allow messages to the first network device when a connection is open based on the packet matching a flow in the flow table 410. This matching is indicated by the response 412. When this matching is missing, the policy table 420 indicates to block messages to the first network device when the packet does not match a flow in the flow table.

The circuitry 401 may include a fabric 428 that interconnects different paths in the circuitry 401 and/or interconnects different circuitries 401 in a single network device. For instance, if the network device includes multiple ASICs, the fabric 428 may interconnect those ASICs and provide a pathway with which such communications may be multiplexed to provide proper routing between the pathways of the one or more ASICs.

The circuitry 401 may perform an egress policy lookup using the egress policy lookup circuitry 430 on packets received over the fabric 428 to determine whether and/or where to transmit such packets out of the network device. The egress policy lookup circuitry 430 may be similar to the ingress policy lookup circuitry 422 except that the ingress policy lookup circuitry 422 performs a lookup applied to packets received at the in port 402 to determine whether to transmit the packet over the fabric 428 and the egress policy lookup circuitry 430 applies a lookup for packets received at the fabric 428 to determine whether to transmit the packet received from the fabric 428 over a network connection, such as an output port. This egress policy lookup circuitry 430 may use the same policy table 420 as the ingress policy lookup circuitry 422 and/or may use a different policy table than is used by the ingress policy lookup circuitry 422.

For messages to be transmitted out from the circuitry 401, the circuitry 401 may use packet modification circuitry 432 to modify such forwarded packets when appropriate. Modifying the forwarded packets may include rewriting the frame of the packet with new source and destination MAC addresses. The circuitry 401 then routes the packet to the next hop neighbor through an out port 434 based on the routing table.

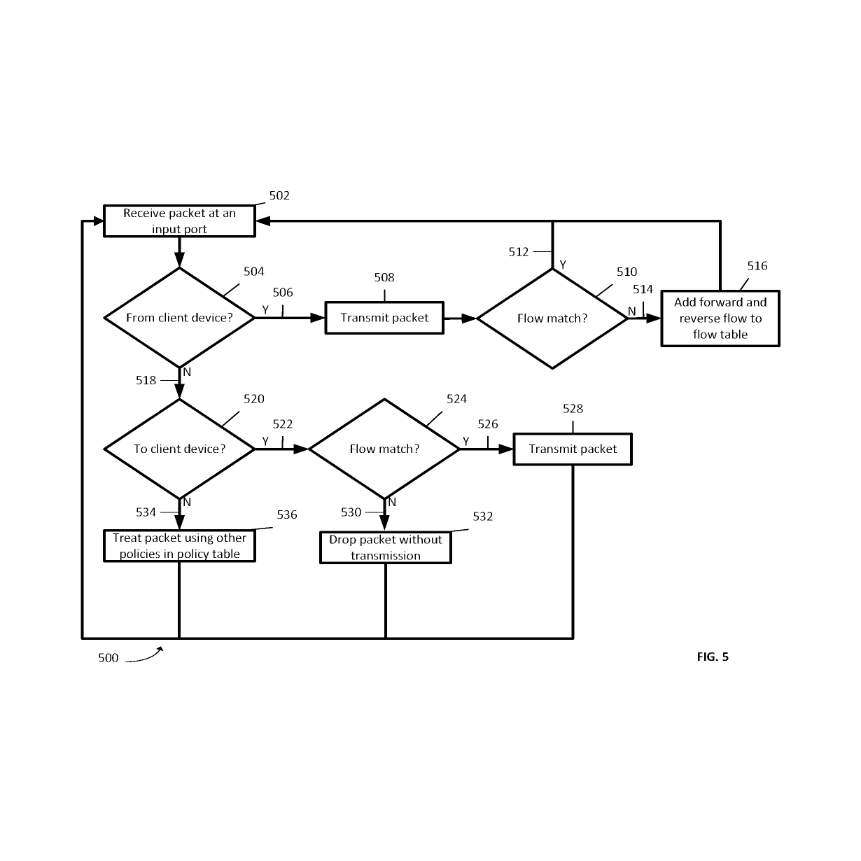

FIG. 5 is a block diagram of a process 500 that is performed by circuitry of a network device. For instance, the circuitry performing the operations of the process 500 may be the one or more ASICs 302 of the computing system 300 and/or the circuitry 401. The circuitry receives a packet at an input port (block 502). For instance, the received packet may be any packet received via an in port, such as the in port 402. The packet may be then converted to bits using layer 1 conversions and also processed using layer 2 and/or layer 3 protocols. Additionally or alternatively, the circuitry may receive the packet from a fabric of the network device.

The circuitry determines whether the packet is received from a client device (block 504). For instance, this determination may be made by examining the headers of the packet indicating a source address and/or port. Furthermore, this source address and/or port may be associated with an entry in the policy table that communications from a specific device, such as the network device 102, should be treated as a client device. Thus, the circuitry may determine that a received packet is from a client device based on the source of the packet and on an internally stored definition of which devices (e.g., addresses) are to be treated as client devices. For instance, such determinations may be performed using the ingress policy lookup circuitry 422 and/or the egress policy lookup circuitry 430 to determine whether packets from the specified device are to be transmitted regardless of the status of a connection.

When the circuitry determines that the received packet is from a client device (line 506), the circuitry transmits the packet (block 508). Where the circuitry transmits the packet may be based at least in part on where the packet is received at the circuitry and where the packet is destined. For instance, if the packet is received at an in port (e.g., the in port 402) with the packet indicating a destination connected to other circuitry (e.g., another ASIC) as indicated by a routing table, the circuitry transmits the packet to a fabric (e.g., the fabric 428) to the other circuitry. Additionally or alternatively, if the packet is received via the in port and/or via a fabric (e.g., the fabric 428) with the packet indicating a destination connected to the circuitry, the circuitry transmits the packet via an out port, such as the out port 434.

Before transmitting the packet, after transmitting the packet, or at least partially concurrently with the transmitting the packet, the circuitry determines whether there is a flow match of the packet with a flow in a flow table (block 510). For example, IP flow lookup circuitry 406 may perform a lookup in the flow table 410 to determine whether an entry exists that corresponds to an existing flow. For instance, the IP flow lookup circuitry 406 may determine whether a previous packet has been received from the same source address and/or port and destined for the same destination address and/or port. Additionally, the IP flow lookup circuitry 406 may determine the previous packet had the same VRF and IP protocol type. In some implementations, the packet may be flagged using metadata or a header to indicate the match. Additionally or alternatively, a flag may be set in the registers of the circuitry to indicate that a flow match has occurred or not occurred. If there is an entry in the table indicating a flow match (line 512), the process may begin again when another packet is received.

If the circuitry determines that there is not a flow match between the packet and any entry in the flow table (line 514), the circuitry adds a forward flow and a reverse flow to the flow table (block 516). The forward flow is an entry in the flow table that corresponds to the directionality of the packet with the same source address, source port, destination address, and destination port. The reverse flow has the source address of the packet as its destination address and vice versa. The reverse flow also has the source port of the packet as its destination port and vice versa. In other words, the reverse flow is in the opposite direction of the forward flow with all other identifying tuples (e.g., IP protocol type, VRF, etc.) of the flow table matching. Since the flow table is used to allow response communications creating the reverse flow entry along with the forward flow entry even without receiving a packet in the reverse direction enables the network device to allow responses in the reverse direction as long as the reverse flow entry remains in the flow table.

Adding the forward flow and the reverse flow to the flow table may include writing the data from the packet to the flow table directly. Additionally or alternatively, the circuitry may add the forward flow and the reverse flow to the flow table using programming via a processing resource, such as the at least one processing resource 416. The circuitry may invoke the programming by the at least one processing resource 416 by sending a flow miss notification, such as the flow miss notification 414. In response to receiving this flow miss notification, the at least one processing resource updates/programs the flow table to include an entry for the forward flow (i.e., in the direction of travel for the packet) and for the reverse flow (i.e., in the opposite direction than the direction of the travel of the packet).

When the circuitry determines that the received packet is not from a client device (line 518), the circuitry determines whether the received packet indicates a destination as a client device (block 520). For instance, the ingress policy lookup circuitry 422 and/or the egress policy lookup circuitry 430 may determine whether a policy in the policy table 420 specifies the destination address as a client device using headers in the packet. If an entry in the policy table 420 specifies that responses are permitted to the destination address when a connection is open, the packet is to the client device.

When the circuitry determines that the packet is to a client device (line 522), the circuitry determines whether there is a flow match between the packet and the flow table (block 524). For example, IP flow lookup circuitry 406 may perform a lookup in the flow table 410 to determine whether an entry exists that corresponds to an existing flow. For instance, the IP flow lookup circuitry 406 may determine whether a previous packet has been transmitted to or received from the same source address and/or port. Additionally, the IP flow lookup circuitry 406 may determine the previous packet had the same VRF and IP protocol type. In some implementations, the packet may be flagged using metadata that flows with the packet or a header to indicate the match. Additionally or alternatively, a flag may be set in the registers of the circuitry to indicate that a flow match has occurred or not occurred.

If there is an entry in the table indicating a flow match (line 526), the circuitry transmits the packet (block 528). Where the circuitry transmits the packet may be based at least in part on where the packet is received at the circuitry and where the packet is destined. For instance, if the packet is received at an in port (e.g., the in port 402) with the packet indicating a destination connected to other circuitry (e.g., another ASIC) as indicated by a routing table, the circuitry transmits the packet to a fabric (e.g., the fabric 428) to the other circuitry. Additionally or alternatively, if the packet is received via the in port and/or via a fabric (e.g., the fabric 428) with the packet indicating a destination connected to the circuitry, the circuitry transmits the packet via an out port, such as the out port 434. With the transmittal of the packet, the process 500 may begin again when another packet is received.

If there is no flow match between the packet and any entry in the flow table but indicated as destined for a client device (line 530), the circuitry drops the packet without transmission (block 532). As such, since there is no flow match, the circuitry assumes that there is no open connection to the client device corresponding to the packet and will not complete the transmission thereby dropping the packet without transmission.

When the circuitry determines that the packet is not destined for a client device (line 534), the circuitry treats the packet using other policies in the policy table (block 536). For instance, if the packet is neither sent from nor destined for a device defined as a client device, other policies in the policy table 420 may be used to determine how to handle the packet. For instance, if the packet is in an allowed pathway, the packet may be allowed while blocked if between devices that are defined as being blocked. Additionally or alternatively, the policies may define namespaces and/or other parameters that may be used to determine whether to allow or block communications through the circuitry. With the transmittal or blockage of the packet based on such policies, the process 500 may begin again when another packet is received.

As previously noted, when a connection is opened by storing entries in the flow table, the circuitry may close the connection. For instance, the client device may close the connection using an explicit request to the circuitry that then removes one or more entries (e.g., forward and reverse flows) from the flow table. The circuitry may directly remove the entries and/or may use the at least one processing resource 416 to delete such entries. After closing the connection, any future communications that are defined as requiring the connection to be open may be dropped/blocked rather than transmitted/allowed. In some situations, the circuitry may close the connection for reasons other than explicit closing from the client device. For instance, as previously discussed, the connection may time out if it has been too long since a last message from the client or may time out if too many messages have been sent from servers/non-clients since a last message was sent from the client.

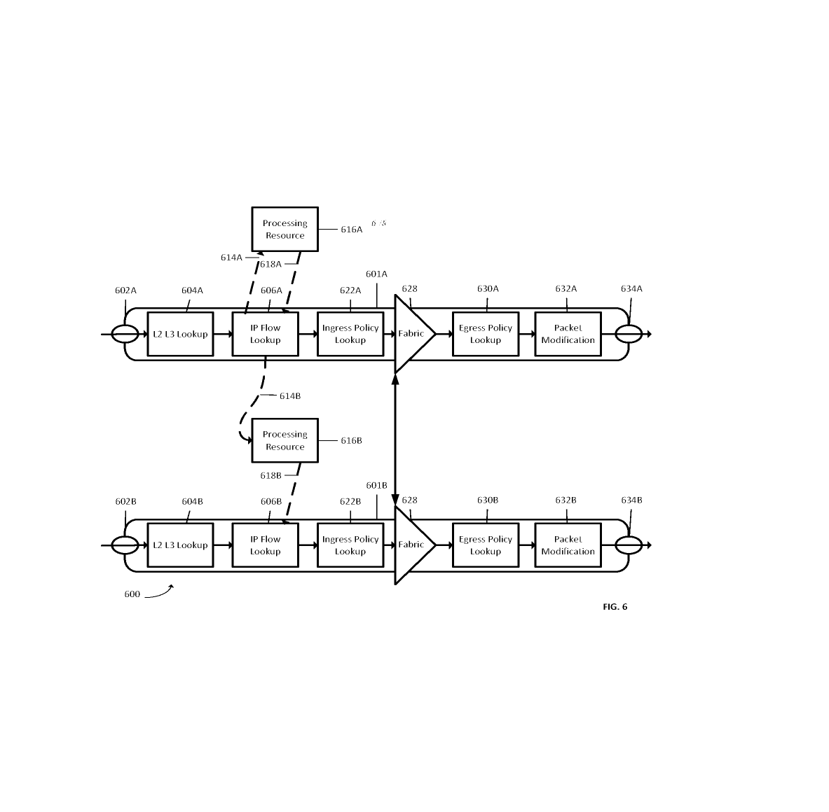

FIG. 6 is a flow diagram of a system 600 that includes circuitries 601A and 601B (collectively referred to as circuitries 601). The circuitries 601 may be of the one or more ASICs 302 and/or the circuitry 401 of a network device, such as the network device 106. Thus, the system 600 may be a network device that includes multiple ASICs 302. For instance, the system may include a network device, such as the network device 106, that may be a chassis or stack switch or other network device that performs asymmetric forwarding within the network device with different network devices connected to different ASICs of the network device. In asymmetric forwarding, a single ASIC may see packets flowing in one direction (e.g., forward flow) but may not ever see packets flowing in the reverse direction (e.g., reverse flow) since reverse flow may be processed by a different ASIC of the network device. In such situations, each ASIC may be unable to tell which side initiated or should be initiating an open connection and how to propagate such open connection statuses through the different flow tables implemented on the different ASICs. One methodology of implementing such stateful techniques in an asymmetric forwarding may be used to program the flow and policy tables directly into a ternary content-addressable memory (TCAM). However, TCAM tables may be relatively expensive and may put a limit on the number of concurrent flows for which reflexive policies may be supported.

Additionally or alternatively, firewall clustering may be used to accommodate asymmetric forwarding. Firewalls may manage asymmetric forwarding by pinning a flow to a certain firewall for both directions of a flow. As such, for firewalls part of a cluster, server-to-client flows and client-to-server flows land on different firewalls in the cluster, but the firewalls may use a flow pinning logic that pins both server-to-client flows and client-to-server flows to a certain designated firewall. When other firewalls receive packets corresponding to the server-to-client flows and client-to-server flows, they steer those packets to that designated firewall for state tracking and stateful policy enforcement purposes.

This flow-pinning, firewall-based solution wastes bandwidth and increases latency as these firewalls may have been capable of sending traffic directly to the recipients instead of deflecting towards the specified firewall for state tracking and policy enforcement. Moreover, this flow-pinning, firewall-based solution uses tunnels that are more complex for a switching fabric as there are fixed ingress/egress pipelines within an ASIC with some ASICs being unable to support such intra-fabric traffic flow-pinning, firewall-based solutions. Instead, the system 600 forwards traffic from the receiving ASIC while also enforcing stateful policies as discussed previously.

Returning to FIG. 6, as illustrated, the circuitries 601 receive incoming data packets at respective in ports 602A and 602B (collectively referred to as in ports 602). The in ports 602 may be any respective connection to an external device, such as the network device 102 or the network device 104, that may receive a packet. The in ports 602 each may use a respective connection, such as an I/O interface 312. For instance, the in ports 602 may receive a packet via an Ethernet connection or another layer 1/physical layer connection from the network device 102 and convert values on the physical layer to bits. Moreover, the in ports 602 may be capable to receive an input packet and/or send output packets.

The circuitries 601 then perform layer 2 and/or layer 3 lookups using layer 2 and/or layer 3 lookup circuitries 604A and 604B (collectively referred to as layer 2 and/or layer 3 lookup circuitries 604). In some implementations, the circuitries 601, such as the one or more ASICs 302, may implement layer 2 forwarding tables. As such, the circuitries 601 use the layer 2 forwarding tables to map forwarding of packets using media access control (MAC) addresses and/or logical link control (LLC) to track which output ports are to be used for which destinations. In addition to or alternative to layer 2 forwarding, the circuitries 601 may implement layer 3 networking to lookup the next hop address in a routing table based on a destination IP address.

The circuitries 601 are configured to perform an Internet Protocol (IP) flow lookup using respective IP flow lookup circuitries 606A and 606B (collectively referred to as IP flow lookup circuitries 606). For instance, the IP flow lookup circuitry 606A may perform a lookup by directly looking up in and/or sending a request to a flow table (e.g., the flow table 410 of the respective ASIC). The circuitries 601 use the flow tables to forward, modify, and look up packets and include an entry for each flow through the circuitries 601 that classifies each packet into a specific flow.

The flow tables (e.g., flow table 410) may be implemented in the respective circuitries as hash tables implemented in buffers of the circuitries 601. These IP flow tables may be indexed by VRF, source IP address, source port, destination IP address, and IP protocol type. As previously noted, the VRF is a layer 3 level isolation mechanism that enables separation of traffic between different virtual private networks (VPNs). For instance, a first packet with a first VRF is isolated from a second packet with a second VRF enabling a single pathway to be treated as different pipelines. Thus, an open connection on one VRF does not allow response messages via a different VRF that does not have an open connection. The source IP address and the source port identify the IP address and port from which packets are received in a flow of the flow table. The destination IP address and the destination port identify the IP address and port to which packets are destined in the flow of the flow table. The IP protocol type indicates a type of IP protocol. For instance, the IP protocol type may specify IP version 4 (IPv4), IP version 6 (IPv6), or another version of the IP.

The circuitry 601A determines that there is no match as a result of the lookup of the flow table. In response, the circuitry 601A sends a flow miss notification 614A to its processing resource 616A indicating that the packet does not match a current flow in the flow table. The IP flow lookup circuitry 606A may also replicate the flow miss notification 614A using hardware duplication to generate one or more duplicated flow miss notifications 614B. These duplicated flow miss notifications 614B are sent to respective processing resources 616B corresponding to each of the circuitries 601 not receiving the packet at their respective in ports 602. The at least one processing resource 616A and one or more processing resources 616B are collectively referred to as processing resources 616.

In response to the flow miss notification 614A or the duplicated flow miss notifications 614B, the processing resource(s) 616 perform updates to their respective flow tables by respective programming operations 618A and 618B. For instance, if a packet received from a client does not correspond to an entry in the flow table, each of the processing resource(s) 616 may create a flow in its corresponding flow table that matches the VRF, source IP address, source port, destination IP address, destination port, and IP protocol type of the packet. In addition, the processing resource(s) 616 may create a reverse flow with the destination IP address and port replacing the respective source IP address and port and vice versa. In other words, the reverse flow is a flow in the exact opposite direction of the flow.

The creation of the forward and reverse flows by the processing resource(s) 616 may be based on policy. This policy may be stored in respective policy tables, such as the policy table. The respective policy tables may be implemented in the respective circuitries 601 and/or in external memory, such as the storage/memory 306. The policy tables may be a literal table or may be any location where policies are stored. For example, the policy tables may include a first policy to allow all communications from a first network device (e.g., the network device 102). This allowance may be indicated by role, such as door badge sensor, camera, and/or any other role in the network. Additionally or alternatively, this policy may be defined on an address basis, such as IP addresses by specific IP addresses and/or by a subnet.

Another defined policy may indicate that transmissions from endpoints back to the first network device are to be allowed when responding to messages from the first network device. In other words, responses to the first network device are to be allowed if a connection is already open. If no connection is open, any transmissions to the first network device are dropped without transmission to the first network device. These principles may be defined using two policies: 1) transmit all packets from the first network device while having the processing resource(s) 616 each program a reverse flow and a forward flow when a flow table miss notification 614A or a duplicated flow table miss notification 614B is received based on a packet from the first network device and 2) transmit packets to the first network device when the packets match a flow in the flow table.

These policies may be duplicated in all of the policy tables used by each of the circuitries 601. In some implementations, each of the policy tables may be duplicated on respective buffers of the respective circuitries 601 from a main policy table implemented in storage, such as the storage/memory 306.

Furthermore, the first network device may close/terminate an open session/connection that it had previously opened. In such a situation, it may instruct the processing resource(s) 616 to reprogram their respective flow tables to remove the flow and any corresponding flows, such as a corresponding reverse flow.

The circuitries 601 each performs an ingress policy lookup of its respective policy table via respective ingress policy lookup circuitries 622A and 622B (collectively referred to as ingress policy lookup circuitries 622). If the policy tables indicate that any received packets match a policy to transmit (e.g., based on role or address of the source) all packets from the first network device, the circuitries 601 transmit any outgoing packets from that source. If the policy tables indicate that a received packet matches a policy to allow messages to the first network device when the packet matches a flow in the flow table 410 as indicated by the response 412 and to block messages to the first network device when the packet does not match a flow in the flow table, the transmission of such packets is dependent on whether a flow match has been indicated using headers or other metadata for the packet that may be flagged by the IP flow lookup circuitries 606.

The circuitries 601 may use one or more fabrics 628 that interconnect the different paths of the circuitries 601. The one or more fabrics enable a packet to be received at an in port 602 of one of the circuitries and output from another port of a different one of the circuitries. For instance, a packet received at the in port 602A that has been determined to be transmitted by the ingress policy lookup circuitry 622A may transmit the packet via the one or more fabrics 628 to the circuitry 601B to be output from the circuitry 601B to another external device.

The circuitries 601 may perform egress policy lookups using egress policy lookup circuitries 630A and 630B (collectively referred to as egress policy lookup circuitries 630). This lookup may be performed on packets received over the fabric to determine whether and/or where to transmit such packets out of the network device. The egress policy lookup circuitries 630 may be similar to the ingress policy lookup circuitries 622 except that the ingress policy lookup circuitries 622 perform a lookup applied to packets received at the respective in ports 602 to determine whether to transmit the packet over the fabric 628 and the egress policy lookup circuitries 630 applies a lookup for packets received at the fabric 628 to determine whether to transmit the packet received from the fabric 628 over a network connection, such as an output port. Each of the respective egress policy lookup circuitries 630 may use the same policy table as a corresponding one of the ingress policy lookup circuitries 622 and/or may use a different policy table than is used by the corresponding ingress policy lookup circuitries 622.

For messages to be transmitted out from the circuitries 601, the circuitries 601 may use packet modification circuitries 632A and 632B to modify such forwarded packets when appropriate. Modifying the forwarded packets may include rewriting the frame of the packet with new source and destination MAC addresses. The circuitries 601 then route the packets to the next hop neighbors through respective out ports 634A and 634B (collectively referred to as out ports 634) based on the routing table.

As may be understood, the processing resource(s) 616 may be used to share miss notifications using a transmission control protocol (TCP) synchronize (SYN) message to establish a connection between the processing resource(s) 616. However, the programming path between the processing resource(s) 616 using software may be relatively slow. Thus, if the at least one processing resource 616A were to receive the flow miss notification 614A and use it to program all flow tables of the each of the circuitries 601, the programming may arrive after a return message is dropped due to the reverse flow programming arriving after the return message. To speed this propagation, the flow miss notification may be hardware duplicated to cause faster replication between the different circuitries 601.

The propagation of the flow miss notification 614A as duplicated flow miss notifications 614B to all of the circuitries 601 may result in flows being stored in flow tables that do not receive the packets between the defined devices in either direction. This proactive preprogramming of flow entries on all circuitries/members of the network device may result in flow table exhaustion when multiple clients open multiple connections. To reduce these issues, one or more of the processing resource(s) 616 may track return flow counters on each of the circuitries 601 to determine where the return traffic is actually received and may remove flow entries that are not active. In other words, rather than selectively programming the flow tables, the network device floods all flow tables indiscriminately and then prunes back the incorrect/unused entries for the sake of speed to ensure that requested response packets are not unintentionally dropped.

In some situations where a forward flow is seen egressing a link aggregation group (LAG) interface, the reverse flow may be retained on all circuitries or stack members that the LAG spans. This ensures that these flows are maintained rather than pruned to enable the network device to perform faster LAG failure recoveries.

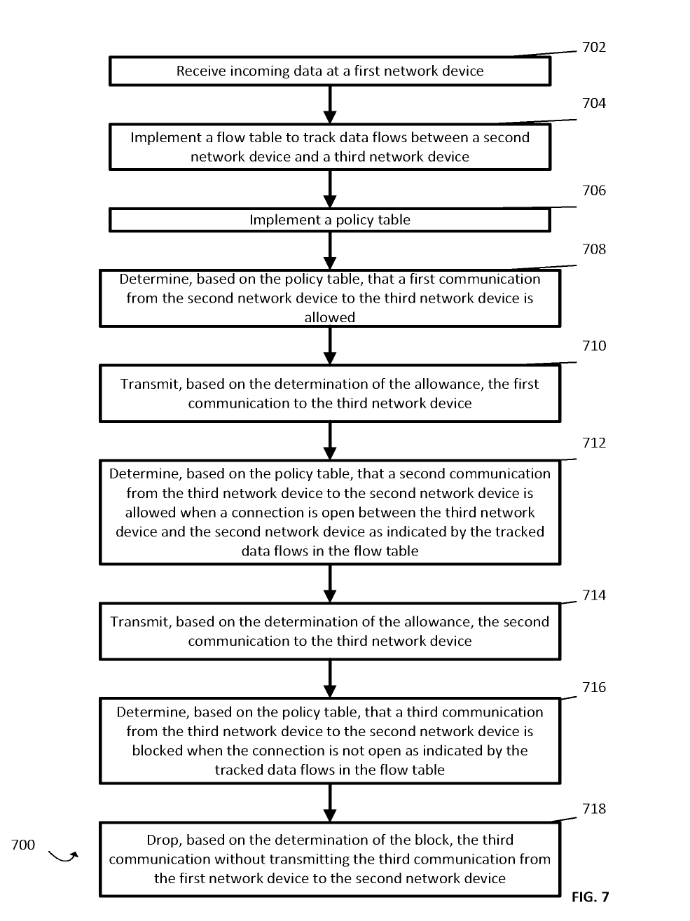

FIG. 7 is a flow diagram for a process 700 that may be implemented in circuitry of a network device, such as the network device 106. For instance, at least some of the steps may be performed using the one or more ASICs 302, the circuitry 401, the circuitries 601, the processing resource(s) 416 and 616, or a combination of such components as previously discussed. A first network device, such as the network device 106, receives incoming data (block 702). The incoming data may be one or more packets received at a respective in port of circuitry. For instance, the incoming packet(s) may be received at an in port 402 of the circuitry 401, an in port 602A of the circuitry 601A, an in port 602B of the circuitry 601B, and/or via the fabrics 428 or 628.

The first network device implements a flow table to track data flows between a second network device and a third network device (block 704). For instance, circuitry of the first network device may implement a flow table in its local buffers. For example, the circuitry 401 may use a buffer to store new flow entries in a flow table 410 each time a packet passes through the first network device that does not match a current entry in the flow table where the packet differs from the entry in at least a VRF, an IP protocol type, a source address, a source port, a destination address, a destination port, or any combination of tuples.

The lack of an entry in the flow table matching the parameters for a particular packet indicates that there is not a current open connection between a client and a server. Once an entry has been created in the flow table, the flow table indicates that an open connection exists between the client and the server. The first network device maintains the flow table by deleting any corresponding flows in the flow table when the first network device receives an instruction from the client to terminate the open connection.

The first network device also implements a policy table (block 706). The policy table, such as the policy table 420, indicates which packets are to be allowed and which packets are to be blocked. The policy table may be implemented in the circuitry of the first network device, such as in the circuitry 401 or the circuitries 601. Additionally or alternatively, the policy table may be implemented in storage, such as the storage/memory 306.

The circuitry of the first network device determines, based on the policy table, that a first communication from the second network device to the third network device is allowed (block 708). For instance, the second network device may be defined as serving the role of a client, such as a (badge) sensor, camera, or other device that may generally send requests to the third network device that is defined as a server to the second network device. The first communication may be a packet from the client to server, and the policy table defines that packets from the client to the server are to be allowed.

The circuitry of the first network device transmits, based on the determination of the allowance, the first communication from the second network device to the third network device (block 710). For instance, the transmission may include transmitting the packet(s) of the first communication to an out port 434, 634A, or 634B. Additionally or alternatively, the transmission may include transmitting the packet(s) of the first communication to other circuitry (e.g., another ASIC) using a fabric, such as the fabrics 428 or 628.

The circuitry of the first network device also determines, based on the policy table, that a second communication from the third network device to the second network device is allowed when a connection is open between the third network device and the second network device as indicated by the tracked data flows in the flow table (block 712). As previously noted, a match of the headers of the packet to an entry in the flow table indicates that there is an open connection between the third network device and the second network device. Circuitry of the first network device, such as the IP flow lookup circuitries 406 and/or 606, may perform this lookup and generate metadata that may be appended to the packet, sent with the packet, and/or stored in the first network device to denote that a match has been found.

The policy table indicates whether packets from the third network device to the second network device are to be allowed when a connection is open (e.g., a flow match in the flow table). Circuitry of the first network device, such as the ingress policy lookup circuitries 422 and/or 622, may perform this lookup to determine whether a policy exists. If such a policy exists in the policy table, the ingress policy lookup circuitries 422 and/or 622 use the policy and the match result metadata to determine that the second communication is to be allowed. The network device then transmits, based on the determination of the allowance, the second communication from the second network device to third network device (block 714).

The circuitry of the first network device may also determine, based on the policy table, that a third communication from the third network device to the second network device is blocked when the connection is not open as indicated by the tracked data flows in the flow table (block 716). Here, the third communication is determined to be blocked from the third network device to the second network device while the second communication was allowed from the third network device to the second network device.

The difference between the third communication being blocked and the second communication being allowed is based on the state of the connection. The third communication had no open connection while the second communication had an open connection. This lack of an open connection may occur if the third communication is received before some packet (e.g., the first communication) from the second network device to the third network device that opens the connection by being stored in the flow table with its reverse flow counterpart. In such a situation, the third communication may be received before the first or second communications are received.

The third communication may still be blocked in some situations where it is received after the first and second communication. For instance, the first communication may open the connection by storing forward and reverse flows in the flow table. The second communication may be received after the first communication (e.g., while the connection is open) and thus may be allowed. After the second communication, the second network device may send an instruction to the first network device to close or terminate the connection. This instruction causes a part, such as a processing resource 614 or 616, of the first network device to remove the entries for the forward and reverse flows from the flow table. After this removal of the entries in the flow table, the third communication is received. When there is no match due to this removal/termination, the circuitry determines that the third communication is blocked.

Regardless of why there is no match, the packet is flagged as unmatched or is not flagged as matched. When the policy table indicates that communications are to be blocked from the third network device to the second network device when the connection is not already open, the circuitry of the first network device drops the third communication without transmitting the third communication from the first network device to the second network device (block 718).

As previously discussed, the processing resources of the first network device may be used to program the flow table with a forward flow with VRF, an IP protocol type, a source address, a source port, a destination address, and a destination port when new packets are sent from a client (e.g., second network device) to a server (e.g., third network device) to track an open connection. The processing resources of the first network device may also program a reverse flow with the source and destination values inverted to denote an opposite direction.

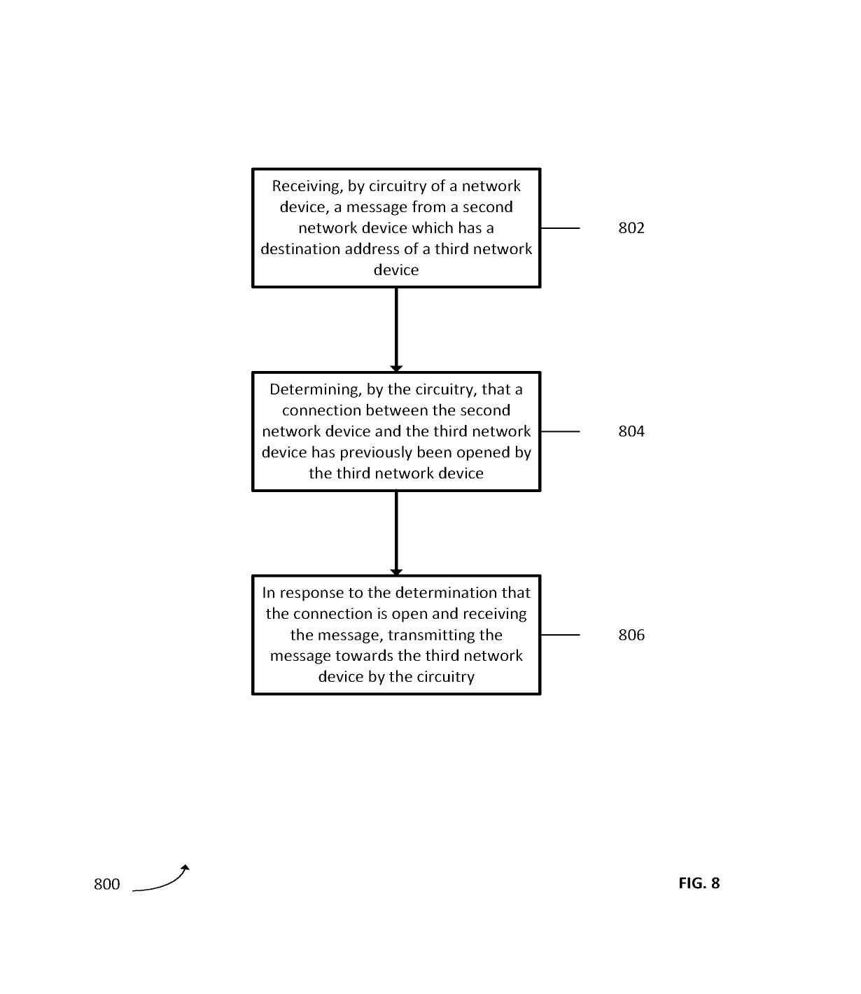

FIG. 8 is a flow diagram of a process 800 used to perform packet/message forwarding in a network device. The circuitry of a network device receives a message from a second network device which has a destination address of a third network device (block 802). For instance, the network device may include the network device 106, and the circuitry of the network device may include the one or more ASICs 302, the circuitry 401, and/or the circuitries 601. The circuitry may determine that the message is from the second network device and targets the third network device using headers/metadata in the message specifying the source and destination nodes for the message. The second network device may be a server that responds to requests from the third network device acting as a client for service requests.

The circuitry then determines that a connection exists between the second network device and the third network device that has previously been opened by the third network device (block 804). Since the third network device may be a client device while the second network device may be a server device, the network device may block unsolicited communications from the second network device to the third network device that is not a response to a message from the third network device.

As previously noted, a flow table, such as the flow table 410, may be used to track messages between the second network device and the third network device via the network device. As such, any message that does not correspond to an existing entry in the flow table may cause the processing resource of the network device to program the flow table to include new entries with the source and destination addresses and ports in both directions. If an entry exists in the flow table that matches the message due to a previously received message, the connection is deemed open, and the message is marked as a match for a default no match scheme or is unmarked as a match for a default match scheme. A policy table of the circuitry of the network device specifies whether a flow matched message is to be transmitted or dropped.

In response to the determination that the connection is open and in response to receiving the message, the circuitry transmits the message toward the third network device (block 806). Transmitting the message may include transmitting the message from an out port, such as the out ports 434 and/or 634 of the network device. Additionally or alternatively, the network device may transmit the message via fabrics to other circuitry, such as to other ASICs via the fabrics 428 and/or 628.

In some implementations, the circuitry may close the connection in response to a request from the third network device, in response to a threshold of time occurring since a last message from the third network device to the second network device, in response to a restart of the network device, in response to a number of return messages from the second network device to the third network device passing a threshold without a new message from the third network device to the second network device, and/or other suitable reasons/mechanisms to close the connection. The network device (e.g., processing resources 616) may close the connection by deleting any forward and reverse flows that match certain parameters, such as a source address, a source port, a destination address, a destination port, a VRF, an IP protocol type, and/or other suitable message parameters.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A network device, comprising:
circuitry configured to:
receive incoming data at the network device;
implement a flow table to track data flows between a second network device and a third network device via the network device;
implement a policy table;
determine, based on the policy table, that a first communication from the second network device to the third network device via the network device is allowed;
transmit the first communication from the network device to the third network device;
determine, based on the policy table, that a second communication from the third network device to the second network device via the network device is allowed when a connection between the third network device to the second network device is open as indicated by the tracked data flows in the flow table;
transmit, based on the determination of the allowance, the second communication from the network device to the second network device;
determine, based on the policy table, that a third communication from the third network device to the second network device via the network device is blocked when the connection is not open between the second network device and the third network device as indicated by the tracked data flows in the flow table; and
drop the third communication without transmitting the third communication to the second network device based on the determination of the block of the third communication.

2. The network device of claim 1, wherein the second network device comprises a client device, and the third network device comprises a server.

3. The network device of claim 1, wherein the connection is open when a previous message has been received at the network device from the second network device targeting the third network device as indicated in the flow table, and the connection has not been terminated by the second network device.

4. The network device of claim 1, wherein the connection is not open when no previous message has been received for the third network device from the second network device as indicated in the flow table.

5. The network device of claim 1, wherein the connection is not open when the second network device has terminated the connection after opening the connection using a previous message as indicated in the flow table.

6. The network device of claim 5, wherein the circuitry is configured to:
receive the previous message at the network device from the second network device;
receive an instruction to close the connection; and
close the connection by updating the flow table.

7. The network device of claim 1, wherein the network device comprises:
at least one processing resource; and
at least one non-transitory, computer-readable medium comprising instructions executable by the at least one processing resource to update the flow table of the circuitry to indicate that the connection is open by storing at least one entry in the flow table when a message is sent from the second network device to the third network device.

8. The network device of claim 7, wherein the at least one entry in the flow table comprises:
a first entry indicating a forward flow of data from the second network device to the third network device through the network device; and
a second entry indicating a reverse flow of data from the third network device to the second network device through the network device.

9. The network device of claim 8, wherein the instructions are executable by the at least one processing resource to:
receive an instruction from the second network device via the circuitry to terminate the connection; and
terminate the connection by deleting the forward flow and the reverse flow from the flow table.

10. The network device of claim 1, wherein the policy table defines a policy for the circuitry to determine whether the connection is open by matching the second network device and the third network device to an entry in the flow table.

11. The network device of claim 1, wherein the circuitry comprises an application-specific integrated circuit.

12. A method, comprising:
receiving, by circuitry of a network device, a message from a second network device which has a destination address of a third network device;
determining, by the circuitry, that a connection between the second network device and the third network device has been previously opened by the third network device; and
in response to the determination that the connection is open and receiving the message, transmitting the message towards the third network device by the circuitry.

13. The method of claim 12, comprising:
receiving a previous message from the third network device to the second network device; and
in response to receiving the previous message, opening the connection by storing one or more entries in a flow table of the network device.

14. The method of claim 13, wherein storing the one or more entries comprises:
storing a first entry indicating a forward flow from the third network device to the second network device; and
storing a second entry indicating a reverse flow from the second network device to the third network device.

15. The method of claim 14, comprising:
closing the connection;
receiving, by the circuitry, a subsequent message from the second network device and that has a destination address of the third network device; and
in response to closing the connection and receiving the subsequent message, blocking transmission of the subsequent message towards the third network device by the circuitry.

16. The method of claim 15, wherein closing the connection comprises deleting the first entry and the second entry, and blocking transmission of the subsequent message is based at least in part on the subsequent message not corresponding to a stored entry in the flow table.

17. The method of claim 15, comprising receiving, at the network device and from the third network device, an instruction to close the connection, wherein closing the connection is in response to the instruction.

18. The method of claim 14, wherein determining that the connection is open comprises verifying that the message matches the forward flow or the reverse flow in the flow table.

19. The method of claim 13, wherein each of the one or more entries comprises:
a source network device for a flow; and
a destination network device for the flow.

20. A network device, comprising:
first circuitry configured to:
communicatively couple to a second network device to send and receive data between the network device and the second network device;
implement a first flow table to track data flows via the first circuitry of the network device;
implement a first policy table to define a first policy to enable data transmissions from the second network device and to define a second policy to selectively enable data transmissions to the second network device when a corresponding entry exists in the first policy table and selectively block data transmissions to the second network device when no corresponding entry exists in the first flow table; and
transmit first data from the network device according to the first and second policies in the first policy table; and
second circuitry configured to:
communicatively couple to a third network device to send and receive data between the network device and the third network device;
implement a second flow table to track data flows via the second circuitry of the network device;
implement a second policy table to define the first policy to enable data transmissions from the second network device and to define the second policy to selectively enable data transmissions to the second network device when a corresponding entry exists in the first policy table and selectively block data transmissions to the second network device when no corresponding entry exists in the second flow table; and
transmit second data from the network device according to the first and second policies in the second policy table; and
a fabric to communicatively couple the first circuitry and the second circuitry together to enable transmission of data between the second network device and the third network device via the first circuitry and the second circuitry of the network device.
